(19) United States
(12) Patent Application Publication
(10) Pub. No.: US 2005/0034311 A1
(43) Pub. Date: Feb. 17, 2005

(54) Figure forming articulating spoon

(76) Inventors: John A. Crane, Downers Grove, IL (US); Judith A. Crane, Chicago, IL (US)

Correspondence Address: KNECHTEL DEMEUR & SAMLAN;ATTN: ALAN B. SAMLAN, 222 S. RIVERSIDE, SUITE 1410, CHICAGO, IL, 60606, US

(21) Appl. No.: 10/637,856

(22) Filed: Aug. 11, 2003

(51) Int. Cl. A47J 43/28

(52) U.S. Cl. 30/324

(57) ABSTRACT

A hand held eating utensil for creating ornamental designs or figures. The eating utensil is a spoon that consists of a main figure handle and a supplemental figure handle having a main figure part and a supplemental figure part, respectively, the combination of which forms a completed or assembled ornamental design or figure. A finger handle and a thumb handle are located at the proximal ends of the main figure handle and supplemental figure handle. The main figure handle also has a base member and the supplemental figure handle has an extension member. Upon the squeezing or spreading of the finger handle in relation to the thumb handle, all the members and handles rotate in a scissors like manner with respect to one another for transforming the spoon from an intermediary or handle open position of apparent broken parts to an extended or handle closed position in which the broken parts form a completed or assembled ornamental design or figure. Situated at the distal end of the supplemental figure handle is a hand bowl for receiving foodstuff.

### I. FIELD OF THE INVENTION

The present invention relates to the design and construction of hand held eating utensils and, more particularly, to an articulating spoon that forms an ornamental design or figure for the amusement of children.

### II. DESCRIPTION OF THE PRIOR ART

Often children need encouragement to eat certain foods or at times merely want to experience a more pleasurable eating experience during meal time. At other times, children merely like to have small toys which can be related to food items as a source of amusement.

Also, food manufacturers often place small items in cereal or candy boxes as promotional items. Such items must be designed so that they can be packaged in a flat configuration, must be inexpensively manufactured, and must be safe in the hands of children. Furthermore, such products may have to meet stringent requirements for food applications. It is also advantageous if such items are easily modified to provide for several different embodiments without changing the overall design concept of the product.

In the past, various types of children's utensils have been developed. For instance, U.S. Pat. No. 2,787,055 entitled “Articulated Toy and Spoon For Hand Feeding an Infant” discloses an articulated toy spoon which protrudes through a face of a cartoon like character. The idea of this device is to take the child's mind off eating and have the child's attention directed toward the cartoon like face through which the spoon protrudes.

Likewise, in U.S. Pat. No. 2,833,084 entitled “Attachment for Child's Eating Utensil” there is disclosed an ornamental attachment to the handle of the spoon which, again, will draw the child's attention to the ornamental handle rather than the food in the bowl of the spoon. In U.S. Pat. No. 4,779,344 entitled “Manipulatable Utensil Figure” another spoon is illustrated having a figure at the end opposite the spoon bowl. The figure can be operated by placing a finger within the figure to manipulate it.

U.S. Pat. No. 2,561,374 entitled “Kitchen Spoon Tongs” illustrates a pair of spoons which are mounted about a pivot point so that the spoons can close around the food to be served. However, there is not any decorative means which would be particularly amusing to a child.

U.S. Pat. No. 510,286 entitled “Spoon” illustrates a spoon which has a pusher/scraper mechanism which conforms to the curvature of the spoon bowl. The scraper operates by pushing it forward along the spoon bowl such that any food in the bowl will be pushed out the front of the bowl. The scraper is operated by merely pushing it from its end opposite the scraper end.

Likewise, Applicant's own U.S. Pat. No. 6,105,254 entitled “Articulating Spoon” discloses a hand held eating utensil having a pair of scissors like handles pivotally connected to each other at approximately their midpoints. A spoon bowl is at the forward end of one of the handles and a pusher mechanism shaped as an animal head is pivotally connected to the forward end of the other handle. As the rear ends of the handles are moved toward each other, the forward portion of the animal head dips down into the spoon bowl and pushes the food contents in the bowl forward out of the bowl.

As can be seen from the prior devices, there has never been disclosed a spoon having a configuration in which multiple handles operate in a scissors like manner for forming an ornamental design or decorative figure. The prior art had imaginative decorative figures which were separately attached to the handle portions of the spoon but none disclosed or taught independent, articulating design members, each integral to the spoon, being used for creating or forming a decorative figure within the spoon.

Accordingly, Applicant's invention has never been disclosed and there is a need for a hand held eating utensil in the general configuration of a figure forming articulating spoon. Furthermore, the eating utensil can be injection molded out of food safe plastic materials in a relatively inexpensive molding process. Also, the pieces can be individually molded and adapted for snapping together. In this manner, the pieces can be stored flat in the cereal or candy box for easy packing and distribution.

### III. OBJECTS OF THE INVENTION

It is the primary object of the present invention to provide a novel construction of an eating utensil which construction allows for the interaction of the user with the decorative and functional figure of the spoon.

A related object of the present invention is to provide a spoon having a pair of spoon handles pivotally connected to each other such that operating the spoon handles toward each other causes the members of the spoon to create an ornamental design or figure.

Another object of the present invention is to provide an easily and inexpensively manufactured spoon which is safe for food products.

Another object of the invention is to provide a spoon made of several spoon parts which can be packaged in a flat configuration and easily assembled by the user.

Still another object is to provide an attractive eating utensil design which induces the child to eat his food and still provide an amusing device for the child to play with, either with or without, any food thereon.

Still another object of the invention is to provide a spoon that is safe and easy to use.

Other objects and advantages of the present invention will become more apparent to persons having ordinary skill in the art to which the present invention pertains from the following description taken in conjunction with the accompanying drawings.

### IV. SUMMARY OF THE INVENTION

The present invention is a hand held eating utensil for creating ornamental designs or figures. The eating utensil is a spoon that consists of a main figure handle and a supplemental figure handle having a main figure part and a supplemental figure part, respectively, the combination of which forms a completed or assembled ornamental design or figure. A finger handle and a thumb handle are located at the distal ends of the main figure handle and supplemental figure handle, respectively. The main figure handle also has a base member and the supplemental figure handle has an extension member. Upon the squeezing or spreading of the finger handle in relation to the thumb handle, the main figure part, the base member, the supplemental figure part, and the extension member all rotate in a scissors like manner with respect to one another for transforming the spoon from an intermediary or handle open position of apparent broken parts to an extended or handle closed position orienting the broken parts in a completed or assembled ornamental design or figure. Situated at the distal end of the supplemental figure handle is a hand bowl for receiving foodstuff.

### V. BRIEF DESCRIPTION OF THE DRAWINGS

The Description of the Preferred Embodiment will be better understood with reference to the following figures:

FIG. 1 is a front elevational view of the inventive spoon showing the articulating members of the spoon in the extended or handle closed position and forming the ornamental design or figure.

FIG. 2 is back elevational view of the inventive spoon and, in particular, illustrating the articulating members of the spoon that are used to transform the spoon between its extended or handle closed position to its intermediary or handle open position.

FIG. 3 is a back view of the extension member of the supplemental figure handle.

FIG. 4 is a back view of the main figure part of the main figure handle.

FIG. 5 is a back view of the base member of the main figure handle.

FIG. 6 is a back view of the supplemental figure part of the supplemental figure handle.

FIG. 7 is a front elevational view showing the articulating members of the spoon in its intermediary or handle open position.

FIG. 8 is a cross sectional view of the pivot pins, taken along line 8-8 of FIG. 2.

### VI. DETAILED DESCRIPTION OF THE PREFERRED EMBODIMENT

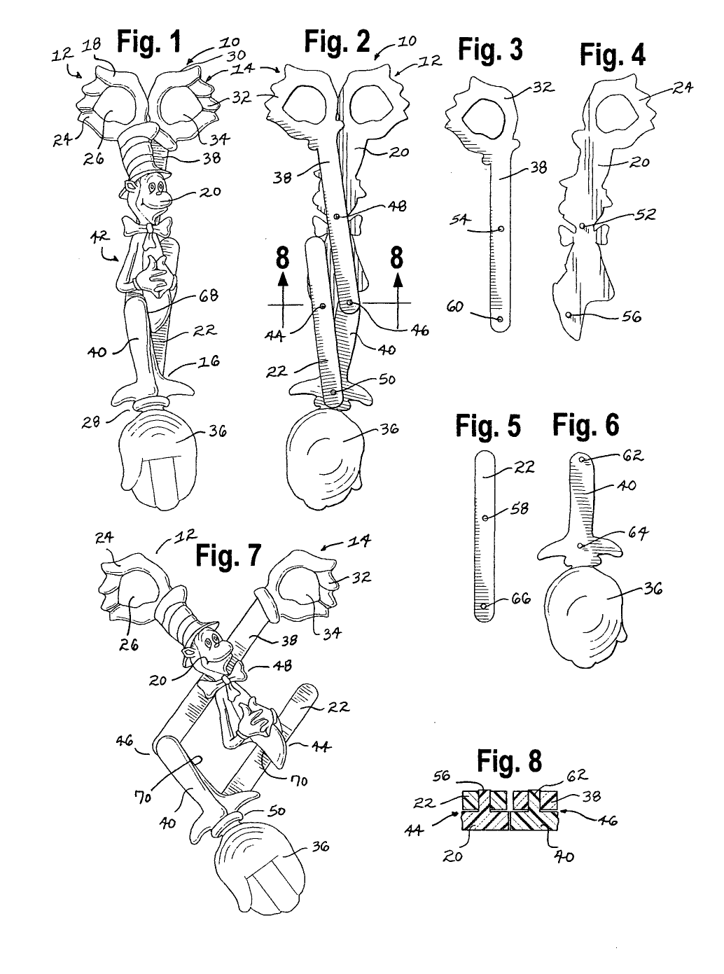

Turning first to FIG. 1, there is illustrated an eating utensil and, more particularly, an articulating spoon 10 as shown in an extended or handle closed position. The spoon 10 is comprised of a pair of handles, namely, a main figure handle 12 and a supplemental figure handle 14. The main figure handle 12 has proximal and distal ends 18 and 16, respectively, and is divided into a main figure part 20 and a base member 22. As depicted and in a non-limiting example, the main figure part 20 is the head and body portion of a cartoon character. Alternatively, it is contemplated that the main figure part 20 can be a portion of any ornamental design or figure. The proximal end 18 of the main figure handle 12 terminates in a finger handle 24 which has formed therein a finger loop 26. In the preferred embodiment, the figure handle 24 is injection molded integrally with the main figure part 20.

The supplemental figure handle 14 has proximal and distal ends 30 and 28, respectively. The proximal end 30 of the supplemental figure handle 14 terminates in a thumb handle 32 which has formed therein a thumb loop 34. The distal end 28 terminates in a hand bowl 36. Between the thumb handle 32 and the hand bowl 36, the supplemental figure handle 14 is divided into an extension member 38 and a supplemental figure part 40. In the preferred embodiment, the thumb handle 32 is injection molded integrally with the extension member 38 and the hand bowl 36 is injection molded integrally with the supplemental figure part 40. As depicted and in a non-limiting example, the supplemental figure part 40 is the legs portion of the cartoon character. The main figure part 20 and the supplemental figure part 40, in combination, create or form a complete ornamental design or FIG. 42. As shown in FIG. 1, the non-limiting combination of the main figure part 20 (i.e., the head and body portion of the cartoon character) and the supplemental figure part 40 (i.e., the legs portion of the cartoon character) form the complete image of the cartoon character. Alternatively, the ornamental design or FIG. 42 may take the shape or form of any real, imaginary, or fictitious character, animal, person, or image.

Turning to FIG. 2, the connection of the articulating handles is more clearly illustrated. With respect to the main figure handle 12, the main figure part 20 is affixed to the base member 22 by main pivot pin 44. With respect to the supplemental figure handle 14, the extension member 38 is affixed to the supplemental figure part 40 by supplemental pivot pin 46.

The main figure handle 12 and the supplemental figure handle 14 are joined to each other at: (1) the approximate mid point of both the main figure part 20 and the extension member 38 as identified by pivot pin top 48; and (2) the approximate mid point of the supplemental figure part 40 and the bottom of the base member 22 as identified by pivot pin bottom 50. As discussed in more detail in FIGS. 3-6 below, all of the pivot pins 44-50 can be integrally molded in one of the members or handles with the other member or handle having a pin receiving hole. Alternatively, a hole can pass through both of either the members or handles with a rivet type assembly passing therethrough in order to hold the members or handles together, yet allow them to rotate with respect to each other around the rivet.

FIGS. 3-6 depict the back side of the extension member 38, the main figure part 20, the base member 22, and the supplemental figure part 40, respectively. With the exception of the hand bowl 36 (FIG. 6), the back side of the members and handles are preferably flat. This facilitates easier connection of the members and handles using the means described in FIG. 2. The main figure part 20 (FIG. 4) and the supplemental figure part 40 (FIG. 6) each extend along the entire length of the member up to the finger handle 24 or hand bowl 36. Alternatively, the main figure part 20 and the supplemental figure part 40 may be any length, size, or shape provided that the combination of these members forms a complete ornamental design or FIG. 42 when the articulating spoon 10 is in the extended or handle closed position. The extension member 38 and the base member 22 are provided to permit the proper alignment and rotation of the main figure part 20 with respect to the supplemental figure part 40. In an alternate embodiment, it is contemplated that depending on the ornamental design or FIG. 42 desired, portions of the FIG. 42 may also be provided by the extension member 38 and/or the base member 22.

The back side of the extension member 38, the main figure part 20, the base member 22, and the supplemental figure part 40 also more clearly illustrate the components forming the pivot pins 44-50. In the preferred embodiment, the pivot pin top 48 (FIG. 2) consists of a pin 52 (FIG. 4) and a pin receiving hole 54 (FIG. 3); the main pivot pin 44 (FIG. 2) consists of a pin 56 (FIG. 4) and a pin receiving hole 58 (FIG. 5); the supplemental pivot pin 46 (FIG. 2) consists of a pin 62 (FIG. 6) and a pin receiving hole 60 (FIG. 3); and the pivot pin bottom 50 (FIG. 2) consists of a pin 64 (FIG. 6) and a pin receiving hole 66 (FIG. 5). For each pivot pin, the pin is integrally molded with the piece from which it extends and is received into a corresponding pin receiving hole. The cross section depicting the connection of the pin and pin receiving hole of the main pivot pin 44 and the supplemental pivot pin 46 are illustrated in FIG. 8.

Turning to FIG. 7, the operation of the articulating spoon 10 can be more clearly described. The operator places his index finger in the finger loop 26 of the main figure handle 12 and thumb in the thumb loop 34 of the supplemental figure handle 14. The operator's fingers then spread the finger handle 24 apart from the thumb handle 32. As this occurs, the main figure part 20 rotates about pivot pin top 48 (FIG. 2) with respect to the extension member 38 and about main pivot pin 44 (FIG. 2) with respect to the base member 22. The supplemental figure part 40 also rotates about supplemental pivot pin 46 (FIG. 2) with respect to extension member 38 and about pivot pin bottom 50 (FIG. 2) with respect to base member 22. Upon rotation of the members and handles in relation to one another, the main figure handle 12 separates from the supplemental figure handle 14 so that the handles assume the intermediary or handle open position as shown in FIG. 7. In this intermediary or handle open position, the FIG. 42 is shown broken or separated into multiple, independent parts with the body separated from the leg.

When the operator desires to return the articulating spoon 10 to the extended or handle closed position, the finger handle 24 of the main figure handle 12 is squeezed and moved toward the thumb handle 32 of the supplemental figure handle 14. Each member and handle is rotated as described herein, thereby, returning the articulating spoon 10 to the extended or handle closed position and again forming FIG. 42, the complete cartoon character as illustrated in FIG. 1. When the main figure part 20 and the supplemental figure part 40 form FIG. 42, a stop means 68 (FIG. 1) is provided for the main figure part 20 and the supplemental figure part 40 to stop the movement of one in relation to the other as the extended or handle closed position is reached. The stop means 68 also provides the means for the proper alignment of the main figure part 20 to the supplemental figure part 40 for forming the complete FIG. 42. The stop means consists of a pair of edges 70 (FIG. 7) located on each side of the main figure part 20 and the supplemental figure part 40 and positioned equal and opposite relative to one another.

The finger handle 24 and the thumb handle 32 can be spread apart or squeezed toward each other causing the transformation of the spoon from the appearance of fractional, unrelated members and handles, in the intermediary or handle open position, to a completed or assembled FIG. 42 in the extended or handle closed position.

During the continual transformation of the articulating spoon 10 between the intermediary or handle open position and the extended or handle closed position, the operator can use the articulating spoon 10 to retrieve any foodstuff in the hand bowl 36 and use the extension or retraction to place the hand bowl 36 in the operator's mouth for eating the foodstuff or, in lieu of eating the foodstuff, the operator may desire to play with the foodstuff while continually forming the figure of the articulating spoon 10.

It is recommended that the individual components be injected molded from a food grade plastic material. Furthermore, the plastic material should not be made of a plastic that is easily chipped or broken, due to the fact that children will be biting on the hand bowl, and the plastic components must have resiliency. The main figure part 20, the base member 22, the extension member 38, and the supplemental figure part 40 can each be injected molded as a separate component and then snapped together to form the finished product. The handles can be textured to resemble, among other things, the features of the character, person, or image or skin of a reptile or other animal.

Thus, there has been provided a figure forming articulating spoon that fully satisfies the objects, aims and advantages of the invention. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the appended claims.

1. A hand held eating utensil, comprising:
a pair of elongated handles pivotally connected to each other in a scissors-like manner, the elongated handles having proximal and distal ends, each elongated handle terminating at its proximal end in a loop, the loops adapted to be grasped by a finger and a thumb of a user of the utensil;
a first portion of a figure provided along one handle;
a second portion of the figure provided along the other handle; and
a bowl affixed at the distal end of one of the handles for receiving foodstuff;
whereby, when the proximal ends of the handles are moved toward each other, the first portion of a figure coacts with the second portion of the figure for forming a completed figure.

2. The eating utensil of claim 1 wherein the pair of elongated handles are operatively connected to one another by means of a pivotal hinge connection for permitting each handle to pivot about the pivotal hinge connection as the proximal ends of the handles are moved toward and away from each other.

3. The eating utensil of claim 1 and further comprising a stop means on the pair of elongated handles for limiting the amount that the one handle can pivot about the pivotal hinge connection with respect to the other handle.

4. The eating utensil of claim 3 wherein the stop means comprises a pair of edges, one edge located on the first portion of a figure and the other edge located on the second portion of the figure, the edge on the first portion of a figure engaging the edge of the second portion of the figure for restricting the pivoting of the one handle in relation to the other.

5. The eating utensil of claim 1 wherein the figure formed by the first portion of a figure and the second portion of the figure may take the shape or form of any real, imaginary, or fictitious character, animal, person, or image.

6. A hand held eating utensil, comprising:
a pair of handles pivotally connected to each other by a pivot connection, each of said handles having proximal and distal ends;
a finger receiving loop at the proximal end of one of the handles and a thumb receiving loop at the proximal end of the other handle;
a bowl at the distal end of one of the handles;
a main figure part forming part of one of the handles between its proximal and distal ends;
a supplemental figure part forming part of the other handle between its proximal and distal ends;
whereby, when the finger receiving loop is moved toward the thumb receiving loop, the main figure part coacts with the supplemental figure part for forming a fully completed figure.

7. The hand held utensil of claim 6 and further comprising a stop means for limiting the amount that the pair of handles can pivot about the other for aligning the main figure part in relation to the supplemental figure part when forming the figure.

8. The eating utensil of claim 6 wherein the figure may take the shape or form of any real, imaginary, or fictitious character, animal, person, or image.

9. A hand held eating utensil, comprising:
a first handle having a main figure part and a base member and proximal and distal ends, the main figure part pivotally connected to the base member;
a second handle having a supplemental figure part and an extension member and proximal and distal ends, the supplemental figure part pivotally connected to the extension member;
the first handle and the second handle pivotally connected to each other by a plurality of pivot connection points,
a bowl at the distal end of one of the handles;
whereby, when the proximal end of the first handle is moved toward the proximal end of the second handle, the first handle pivotally rotates with respect to the second handle such that the main figure part and the supplemental figure part are correspondingly aligned for creating a fully completed figure.

10. The hand held eating utensil of claim 9 wherein the plurality of pivot connection points comprises a first pivot connection point and a second pivot connection point, the first pivot connection point enabling the main figure part of the first handle to pivot about the extension member of the second handle, the second pivot connection point enabling the supplemental figure part of the second handle to pivot about the base member of the first handle.

11. The hand held eating utensil of claim 9 wherein when the first handle pivotally rotates with respect to the second handle, the main figure part pivotally rotates in relation to the base member and the extension member and the supplemental figure part pivotally rotate in relation to the extension member and the base member.

12. The hand held eating utensil of claim 11 wherein the main figure part and the supplemental figure part each have a plurality of pins and the base member and the extension member each have a plurality of pin receiving holes for receiving the plurality of pins.

13. The hand held eating utensil of claim 12 wherein the plurality of pins are received by the plurality of pin receiving holes.

14. The eating utensil of claim 9 wherein the figure formed by the main figure part and the supplemental figure part may take the shape or form of any real, imaginary, or fictitious character, animal, person, or image.

15. A method for forming a figure using a hand held eating utensil, comprising the steps of:
providing a pair of elongated handles pivotally connected to each other in a scissors-like manner, the elongated handles having proximal and distal ends, each elongated handle terminating at its proximal end in a loop, the loops adapted to be grasped by a finger and a thumb of a user of the utensil, a first portion of a figure provided along one handle, a second portion of the figure provided along the other handle, a bowl affixed at the distal end of one of the handles for receiving foodstuff;
inserting a finger into the finger receiving loop;
inserting a thumb into the thumb receiving loop;
moving the finger receiving loop towards the thumb receiving loop for pivotally rotating the pair of elongated handles in relation to each other;
aligning the first portion of a figure of one handle to the second portion of the figure of the other handle; and
forming a fully completed ornamental design or figure.

16. The method of claim 15 and further comprising the step of stopping the first portion of a figure in relation to the second portion of the figure when the ornamental design or figure is fully completed.

17. A method for forming a figure using a hand held eating utensil, comprising the steps of:
providing a first handle having a main figure part and a base member, the main figure part pivotally connected to the base member, a second handle having a supplemental figure part and an extension member, the supplemental figure part pivotally connected to the extension member, the first handle and the second handle pivotally connected to each other by a plurality of pivot connection points, a finger receiving loop a proximal end of one of the handles and a thumb receiving loop a proximal end of the other handle, a bowl at a distal end of one of the handles;
inserting a finger into the finger receiving loop;
inserting a thumb into the thumb receiving loop;
moving the finger receiving loop towards the thumb receiving loop for pivotally rotating the first handle in relation to the second handle;
aligning the main figure part of the first handle to the supplemental figure part of the second handle; and
forming a fully completed ornamental design or figure.
